(19) United States
(12) Patent Application Publication
(10) Pub. No.: US 2024/0343198 A1
(43) Pub. Date: Oct. 17, 2024

(54) FLIP-OVER LADDER SYSTEM

(71) Applicant: Adam TRIPP, Hudson, WI (US)

(72) Inventor: Adam TRIPP, Hudson, WI (US)

(21) Appl. No.: 18/294,980

(22) PCT Filed: Oct. 11, 2022
(86) PCT No.: PCT/US2022/046294

§ 371 Date: Feb. 2, 2024

Related U.S. Application Data
(60) Provisional application No. 63/254,011, filed on Oct. 8, 2021.

(51) Int. Cl. B60R 3/02; E06C 5/02; E06C 5/32; E06C 9/08

(52) U.S. Cl. CPC B60R 3/02; E06C 5/02; E06C 5/32; E06C 9/08

(57) ABSTRACT

A flip-over ladder system includes a handle assembly configured to be mounted to a front face of a wall. The system further includes a ladder assembly, including first and second rail assemblies defining left and right sides of said ladder assembly, at least one rung spanning said first and second rail assembly, first and second bracket members, each configured to be both secured to said front face of said wall, and to vertically support said first and second rail assemblies, respectively. Each of said first and second rail assemblies comprises a bottom rail segment hingedly coupled to a middle rail segment, a middle rail segment hingedly coupled to an upper rail segment, and wherein said upper rail segment is hingedly connected to said first and second bracket member, respectively.

### CROSS REFERENCE TO RELATED APPLICATIONS

This application claims priority to and the benefit of U.S. Provisional Patent Application No. 63/254,011, filed on Oct. 8, 2021, the content of which is incorporated by reference in its entirety as if fully set forth herein.

### TECHNICAL FIELD

This disclosure relates to articulatable ladders: systems and methods for ascending a ladder to a top portion of a first side of a wall, at least partially dismounting the ladder, rotating the ladder over the top portion to a second side of the wall opposite the first side, and descending the ladder.

### BACKGROUND

The first ladders are thought to originate from Hebrew and Egyptian cultures thousands of years ago, where they were used to access heights previously unattainable. Since then, many different types of ladders have been conceived from simple, fixed-length ladders to those that are able to transform between ultra-compact and extended configurations. Extension ladders offer the capability of variable length, while A-frame ladders provide self-supporting capability when there is no structure to lean a straight ladder against. Some ladders are small and lightweight such that they can be carried by an individual, while other types, such as those used for firefighting require complex and powerful machinery to manipulate them as desired.

Ladders allow humans to conquer height, and in many cases the same ladder is used to both ascend and descent from a given height. For example, roofers ascend and descend ladders during their work to deliver materials and supplies to the roof. In this case, a straight ladder can be sufficient. However, a problem exists when one wishes to ascend to a height, such as the top of a wall, and descend on the other side of the wall. If a second ladder is not already present for the descent, the user must either carry another ladder (e.g., a rope ladder) or, after reaching the top of the wall, lift the ladder up and over the wall, allowing it to be placed on the other side. If the wall at issue has any appreciable height, such actions can be extremely dangerous and lead to falls causing injury or death.

While not to the same extreme, situations exist in common workplace environments where a user must climb up and over a certain barrier. In one example, dump truck operators are commonly required to inspect the contents of the load or the integrity of the dump truck bed. To accommodate the operator, ladders are often times mounted or built into the exterior and interior side portions of the truck bed. This allows the operator to, for example, scale the exterior ladder, negotiate the top of the truck bed by swinging his torso over the top, and descend into the truck bed by way of the interior-mounted ladder. However, it is often the case that dump trucks carry loads of materials such as rocks, concrete debris or other large, heavy materials that can destroy the interior ladder or at the very least, reduce the integrity of the ladder materials, thereby creating a safety hazard.

Accordingly, an articulatable ladder system providing the ability to scale a first side of a wall and subsequently be rotated over the top of the wall to allow a user to descend the other side is an unmet need in the art. In a trucking environment, such a concept allows a ladder to be stored on an external portion of a truck bed when not in use, so that the ladder is not destroyed or compromised by day-to-day trucking or hauling activities, while allowing a user a safe and effective ascent and descent into the truck bed itself. Such ability is a particularly unmet need in the trucking and hauling industry.

### SUMMARY

In one exemplary aspect, a ladder system is disclosed. In an embodiment, the ladder system includes a handle assembly configured to be mounted to a front face of a wall and a ladder assembly. The ladder assembly includes first and second rail assemblies defining left and right sides of the ladder assembly, at least one rung spanning the first and second rail assembly, first and second bracket members, each configured to be both secured to the front face of the wall, and to vertically support the first and second rail assemblies, respectively. Each of the first and second rail assemblies includes a bottom rail segment hingedly coupled to a middle rail segment, a middle rail segment hingedly coupled to an upper rail segment, and wherein the upper rail segment is hingedly connected to the first and second bracket member, respectively; and wherein a length of the middle rail segment is selected to be wider than a width of the wall.

In one embodiment, the handle assembly includes a mounting plate, a locking body integral with the mounting plate, and a gripping assembly hingedly coupled to the mounting plate. The grip member can be configured to rotatably translate between first and second positions, wherein in the first position the grip member is oriented downward, and wherein in the second position, the grip member is oriented upward. The gripping assembly includes a bracket member hingedly coupled to the plate member and a grip rotatably coupled to the bracket member, the grip being configured to freely rotate with respect to the bracket member. The locking body includes a slotted aperture allowing the gripping assembly to translate along an axis, and first and second locking apertures configured to selectively lock the gripping assembly in either the first or second position.

In one embodiment, the ladder assembly further includes a brace member spanning the first and second rail assemblies. The brace member can be U-shaped.

In another embodiment, the ladder assembly includes a handle assembly configured to be mounted to a front face of a wall, a ladder assembly including first and second rails, each of the first and second rails including first, second and third hinged segments, the first segment being hingedly coupled to the second segment, and the second segment being hingedly coupled to the third segment. A length of the second segment is chosen to be longer than the width of the wall onto which the ladder assembly is to be attached.

In one embodiment, the ladder further includes at least one rung spanning the first and second rail.

In one embodiment, each of the first and the second rails is hingedly coupled to a bracket to allow at least 180° rotation of the rails. The bracket can further be configured to be mounted to the front face of the wall.

In one embodiment, the ladder assembly is configured to allow the first and second rails to be rotated such that the first segment remains on the same side of the wall as the front face, the second segment confronts a top portion of the wall, and the third portion is vertically suspended by the second segment on an opposite, rear side of the wall than the front face.

In one embodiment, the ladder assembly is configured such that the rails of the third segment is capable of adopting a vertical orientation on both front and rear sides of the wall.

In one embodiment, the handle assembly is capable of shifting between upward and downward vertical orientations.

In one embodiment the handle assembly can be reversibly locked in either of the upward or downward vertical orientations.

In yet another aspect, a method for providing access to a dump truck dump body is disclosed. The method includes determining a wall thickness and, optionally, a wall profile at a top portion of the dump body and providing a ladder system. The ladder system includes a ladder assembly, including first and second rail assemblies defining left and right sides of the ladder assembly, at least one rung spanning the first and second rail assembly, first and second bracket members, each configured to be both secured to an exterior portion of the dump body, and to vertically support the first and second rail assemblies, respectively. Each of the first and second rail assemblies includes a lower rail segment hingedly coupled to a middle rail segment, a middle rail segment hingedly coupled to an upper rail segment, and wherein the upper rail segment is hingedly connected to the first and second bracket member, respectively. A length of the middle rail segment is selected to be wider than the wall thickness. The method further includes providing a handle assembly configured to be mounted to the exterior portion of the dump body and attaching the first and second bracket members to the exterior portion of the dump body at a position below the top portion of the dump body that is not greater in length than a length of the first upper rail segment.

In one embodiment, the method further includes providing that a grip of the handle assembly is capable of rotating 360°.

In one embodiment, the method further includes attaching the handle assembly to the exterior of the dump body such that a grip of the handle can be rotated from a downward orientation to an upward orientation. When the grip of the handle is in the upward orientation, the grip can be positioned above the top portion of the dump body.

In one embodiment, the method further includes positioning the bracket members such that the middle rail segment is capable of laying substantially flush on a surface of the top portion of the dump body.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 is a flip-over ladder system according to a first embodiment:

FIG. 2 illustrates the flip-over ladder system of FIG. 1 being rotated over a front face of a wall;

FIG. 3 illustrates portions of the flip-over ladder system of FIG. 2 after the ladder has been flipped over the front face of the wall:

FIG. 4 illustrates the portions of the flip-over ladder system of FIG. 2 on a rear side of the wall, after being flipped over the wall;

FIG. 5 illustrates portions of a handle assembly that are part of the flip-over ladder system shown in FIG. 1:

FIGS. 6-7 illustrate the handle assembly of FIG. 5 being transitioned from downward (FIG. 6) to upward (FIG. 7) orientations:

FIG. 8 is a flip-over ladder system according to a second embodiment, illustrated attached to a front face of a wall:

FIG. 9 illustrates the flip-over ladder system of FIG. 8 flipped over the front face of the wall:

FIG. 10 illustrates the flip-over ladder system of FIG. 8 on the rear side of the wall; and

FIG. 11 illustrates an embodiment of a locking mechanism for a flip-over ladder system.

### DETAILED DESCRIPTION OF ILLUSTRATIVE EMBODIMENTS

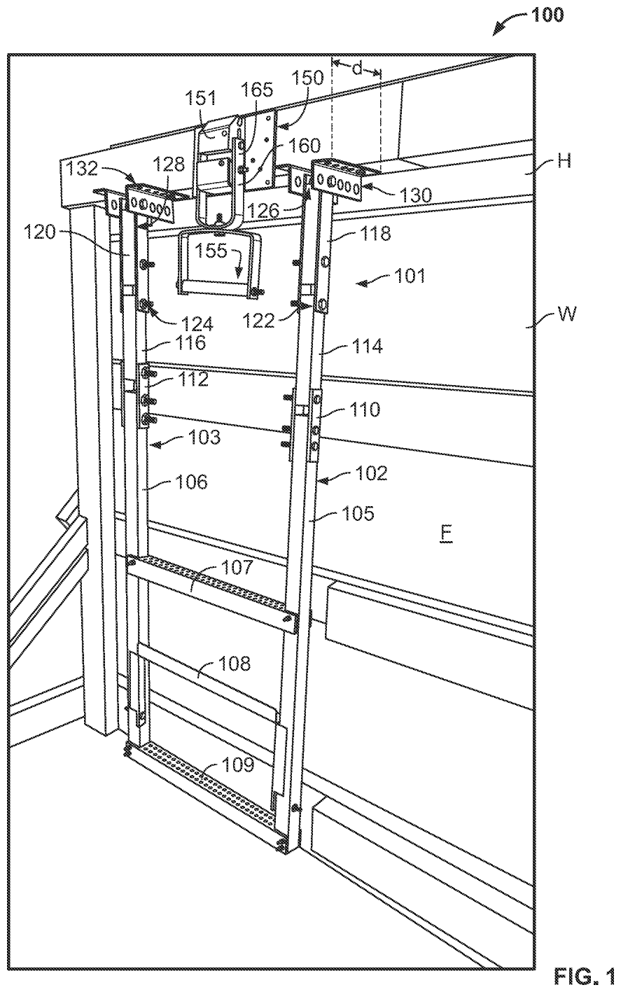

FIG. 1 is a flip-over ladder system 100 according to one embodiment. In this embodiment, the system 100 includes a flip-over ladder (hereinafter ‘ladder’) 101 and a handle assembly 150. Each of the ladder 101 and handle assembly 150 are configured to be mounted to a portion of wall W as described in greater detail below. Wall W can be any type of wall: for example, a wall of a building, a wall of a dump body of a dump truck, or other wall.

In general, the ladder system 100 allows a person to ascend one side of a wall W, flip the ladder 101 over the top of the wall W, and descend on the opposite side of the wall W.

Turning now to specific portions of the ladder 101 and handle assembly 150 shown in FIG. 1, in this embodiment, the ladder 101 includes right (102) and left (103) rail assemblies formed of individual segments. For example, the right rail assembly 102 includes a lower segment 105, a middle segment 114 and an upper segment 118. Each of the segments is connected to form the rail assembly 102 by way of hinges that allow each of the segments to pivot at their connection point to the hinge. For example, segment 105 is connected to segment 114 by way of hinge member 110. Hinge member 110 allows each of segments 114 and 110 to pivot where attached to hinge member 110. In this example, hinge member 110 is slightly wider than the width of segments 114 and 110 and includes two sets of apertures. The end portions of segments 114 and 110 each include a set of apertures that align with the apertures of the hinge 110 when inserted therein. A bolt or other retaining member can then be fed through the apertures of the hinge and segments, respectively, to form a pivotable connection. Middle segment 114 is hingedly connected to upper segment 118 by way of a bolt 122. A pivot point between middle segment 114 and upper segment 118 is defined at the location of bolt 122.

The left rail assembly 103 is similarly constructed: i.e., lower segment 106 connects to middle segment 116 by way of hinge member 112. Middle segment 116 is hingedly connected to upper segment 120 by way of bolt 124. It should be understood that the segments of each rail assemblies may be hingedly joined to each other by alternative methods or using alternative hardware.

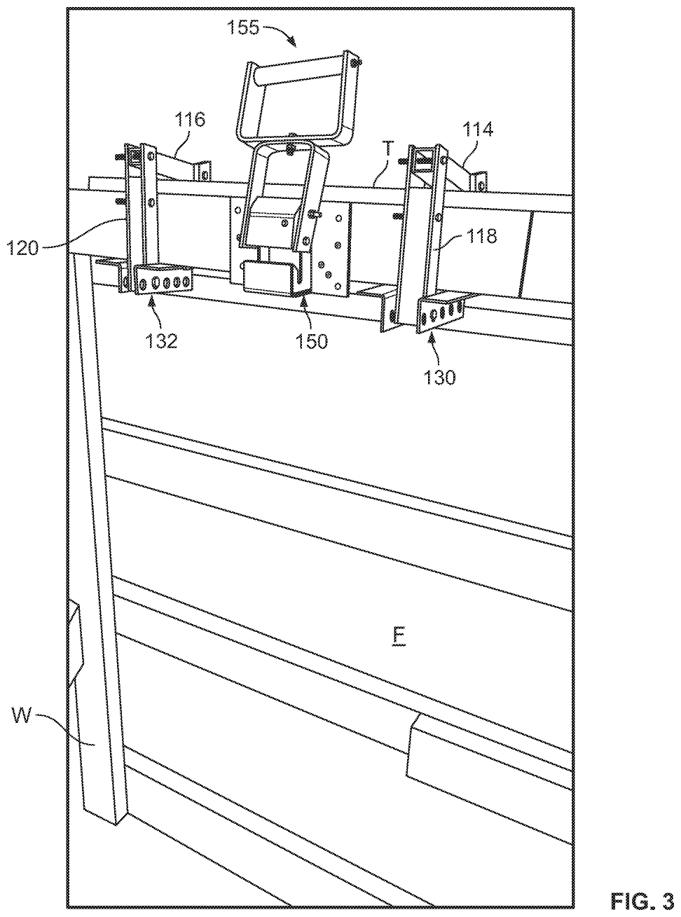

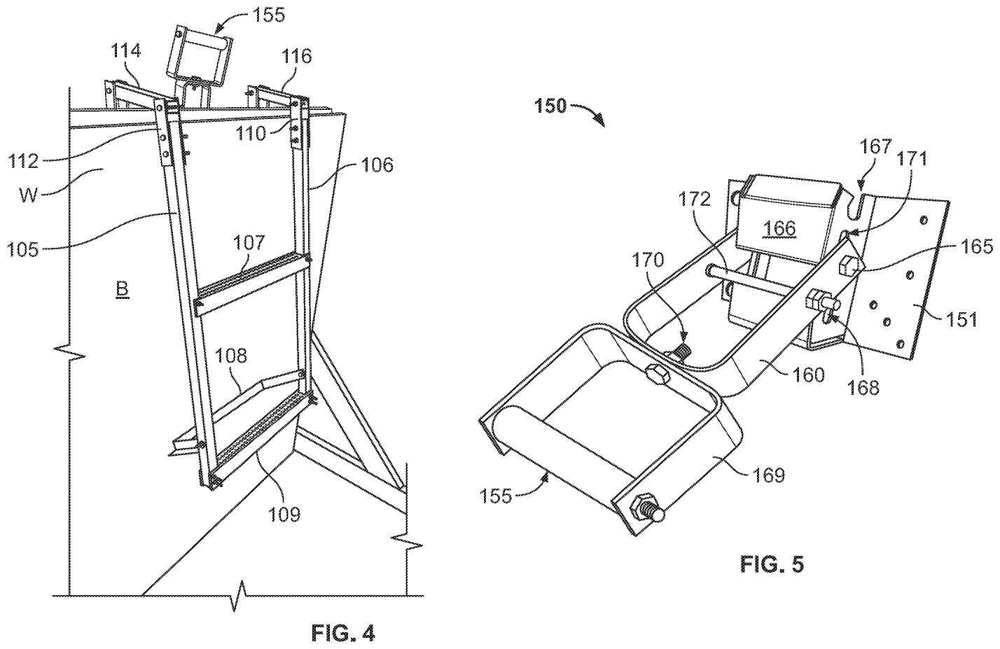

In this embodiment, a first rung 107 spans the right (102) and left (103) rail assemblies. The rung 107 can include anti-slip features, such as a roughened, raised or gripping surface to reduce the likelihood of slipping. Rungs 107 and 109 provide steps by which a user can ascend the ladder 101 in the extended configuration shown, e.g., in FIG. 1. In this embodiment, a rotatable brace 108 can shift between parallel (as shown in FIG. 1) and perpendicular (as shown in FIG. 4) configurations with respect to rails 102 and 103, to make the ladder 101 stand off from the wall W.

In this embodiment, right (130) and left (132) brackets are secured to the header H (or other upper portion) of the wall W. Each of the right (130) and left (132) brackets extend perpendicularly from the wall W a distance d and provide a pivotal attachment point for each of the right (118) and left (120) upper segments as illustrated. Each of the right (118) and left (120) upper segments are joined to a distal end portion of the right (130) and left (132) brackets, respectively, by right (126) and left (128) bolts that pass through apertures formed in the brackets and upper segments, allowing the upper segments to rotate about the bolts at least 180°.

In this embodiment, the handle assembly 150 of the flip-over ladder system 100 is intended to be mounted at or near a top-most portion of the wall W, such as on wall header H as illustrated. In this embodiment, the handle assembly 150 includes a plate 151 that is configured to be attached to the wall W at or near the top of the ladder 101 as illustrated. Alternatively, plate 151 can be exchanged with a U-shaped bracket that may be attached, e.g., by welding to the wall W to accomplish the same or similar functionality. Pivotally joined to plate 151 by a retaining bolt 165 is a bracket member 160 that itself is joined with a grip 155. Grip 155 is intended to be grasped by a user for stability and/or to aid in ascending or descending the ladder 101.

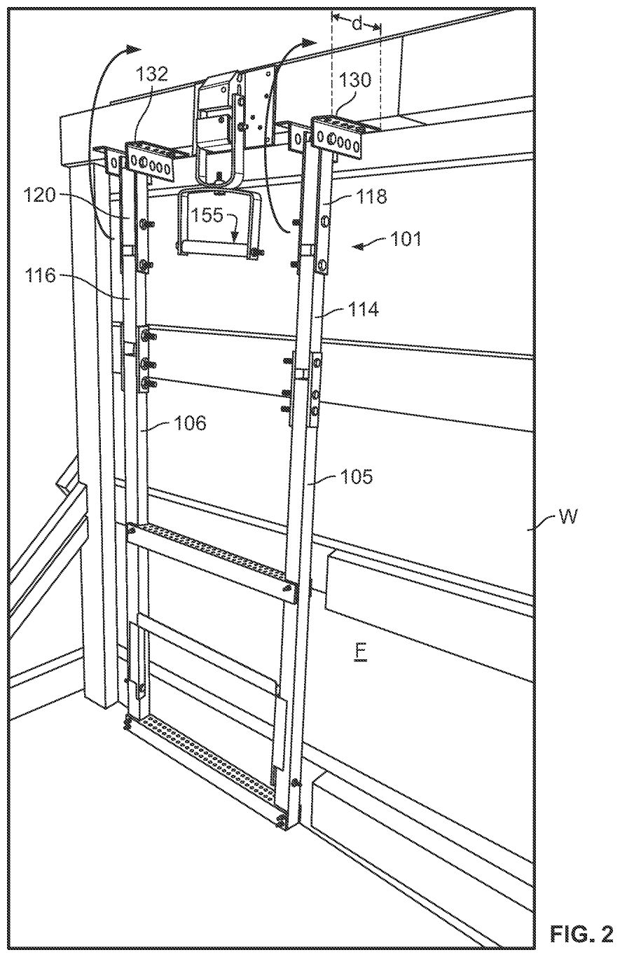

Referring now to FIGS. 2-4, the operation of the ladder system 100 is illustrated according to one embodiment (only select reference numerals are included in FIGS. 2-4 to maintain clarity of the figures). In FIG. 2, the ladder system 100 is in the same extended configuration along the front (F) wall W as shown in FIG. 1.

In an exemplary and non-limiting use, a user may ascend the ladder 101, using the grip 155 of handle 150 as necessary to reach the top of the wall W. Once on top of the wall W, the user may step off the ladder 101, thereafter straddling or seating himself on the top portion of the wall W. Next, the user may reach down and grasp a portion of the ladder 101, such as upper segments 118 and/or 120, middle segments 114 and/or 116, or another portion of the ladder 101, e.g., segments 106 or 105. In one example, the ladder 101 may include a tether (not shown in the figures) that allows the user to pull up on a selected portion of the ladder 101 such as the third rung 109 on the bottom portion of the ladder 101.

The user may then swing the ladder 101 upward, in the direction depicted by the curved arrow in FIG. 2. In doing so, upper segments 118 and 120 pivot approximately 180°, from a downward-facing direction as illustrated in FIGS. 1 and 2 to an upward facing direction as illustrated in FIG. 3. As the user continues to transition the ladder 101 from the front (F) of the wall W to the back (B) of the wall W, middle segments 114 and 116 confront the top surface T of the wall W, forming an “L” shape with upper segments 118 and 120, respectively. The right (130) and left (132) brackets continue to secure upper segments 118 and 120 which are hingedly secured to middle segments 114 and 116, respectively. In this configuration, middle segments 114 and 116 now serve as the top portion of the ladder on the back side (B) of the wall W. The user may pivot the grip 155 of handle 150 such that it faces upward, 180° or more from its downward-facing direction illustrated in FIG. 1.

Referring to FIGS. 3 and 4, ladder 101 and handle assembly 150 are shown in a configuration suitable to scale the back (B) side of wall W. In this configuration, hinge members 110 and 112 vertically support bottom segments 105 and 106 of ladder 101, respectively. Rungs 107 and 109 are presented as footsteps so that the user may use the ladder 101 in the configuration shown to descend the back side (B) of wall W; and grip 155 is in an orientation suitable to be used as a hand stabilizer as the user mounts the ladder. Rotatable and lockable brace 108 is rotated at least 90° and pinned to lower segments 105 and 106 so that the ladder rungs 107 and 109 are spaced from the surface of the back (B) of wall W. This allows a user to place their foot firmly on rungs 107 and 109, e.g., at the arch of the foot, for increased safety and reliability.

In this embodiment, a criticality arises in the length of upper sections 114/116. In particular, it is necessary that each combination of upper section 114 (116) and hinge member 110 (112) be greater in length than the width of the wall W. If the combinations are shorter than the width of wall W, bottom segments 105/106 may not be able to rotate into a downward configuration as illustrated, e.g., in FIG. 4. Another criticality includes selection of the overall length of the ladder. In one aspect, the overall length of the ladder should be selected so as not to interfere with wheels or other components of the truck when the ladder is stored on the outside of the truck (e.g., the front of the wall). In addition, the length of the ladder components that fall inside the dump body when used on the inside of the truck (e.g., the back wall) should be selected so that the bottom of the ladder—e.g., rung 109 does not land on, or confront the floor of the dump body. The ladder may be used in concert with another fixed ladder or steps on the outside of the wall.

Referring now to FIG. 5, portions of handle 150 are shown and described in greater detail. In this embodiment, as has been discussed, handle 150 includes a plate 151 formed of a material preferably able to withstand weathering and of sufficient strength to support the weight of a user. Examples of such materials are aluminum and stainless steel, although other embodiments may utilize other materials.

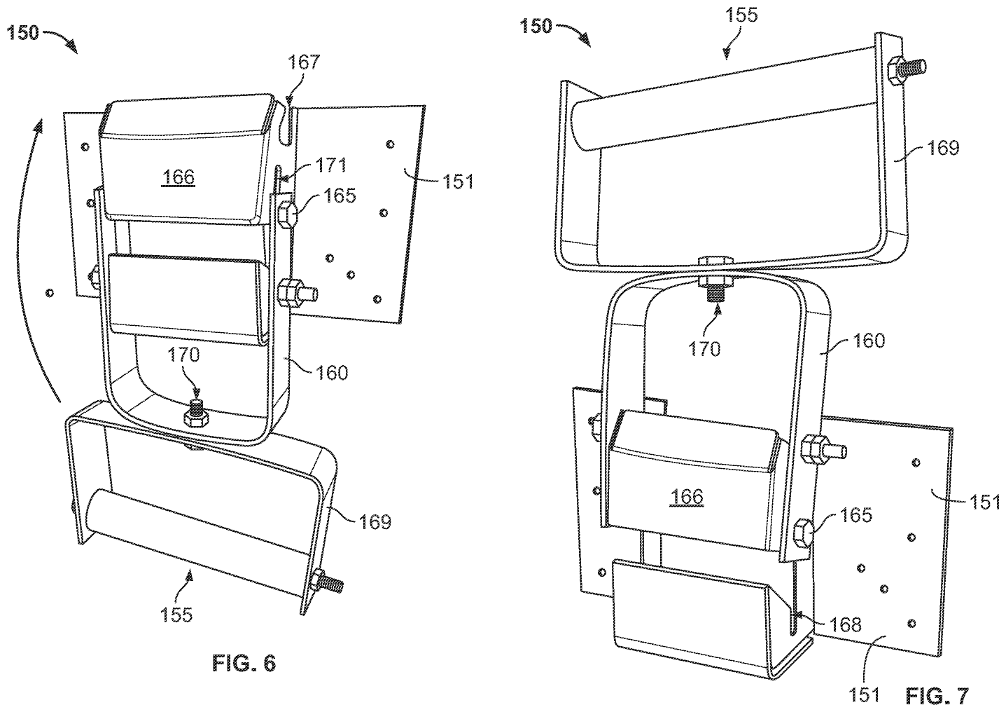

In this embodiment, the handle assembly 150 includes a locking body 166 integral with plate 151. The locking body extends approximately perpendicularly from the plate 151 and includes two locking slots 167 and 168. Each of the locking slots 167 and 168 are formed and configured to receive a cross-bar member 172 disposed between opposite sides of U-shaped bracket member 160 as shown. Bracket member 160 is configured to pivot approximately 180° between a “down” configuration (e.g., as shown in FIG. 6) and an “up” configuration (e.g., as shown in FIG. 7). In this embodiment, the sides of U-shaped bracket member 160 fit on either side of locking body 166 and is secured in place with retaining bolt 165.

In this embodiment, grip 155 is configured to rotate 360° with respect to U-shaped bracket member 160. Such a configuration provides the ability of a user ascending one side of a wall while gripping grip 155 and descending the opposite side of the wall without releasing grip 155. Grip 155 is positioned between a second U-shaped bracket 169 that is rotatably fastened to bracket member 160 by way of a retaining bolt 170, although other methods or hardware can be used to accomplish the same functionality.

In this embodiment, locking body 166 includes a slot 171. Slot 171 is configured to provide the capability for retaining bolt 165 to translate vertically, i.e., parallel with the plane of plate 151. Slot 171, locking slots 167, 168 and cross-bar member 172 cooperatively provide the capability to lock the handle assembly 150 into a desired configuration for ascending or descending the ladder 101. The handle may also be used to assist a user ascending a fixed ladder in proximity to the ladder system 100, if one is present.

For example, FIG. 6 illustrates the handle assembly 150 with the grip 155 in the “down” configuration, suited for a user ascending ladder 101 on the front (F) face of a wall W (FIG. 1). In this configuration, bracket member 160 is also in a downward configuration: cross-bar member 172 is seated within the lower locking slot 168. Such a configuration can reduce the likelihood of the handle ‘swinging’ and provide greater reliability for the user. A tab can alternatively be added to bracket 151/166 to prevent rotating in the down position.

After a user has ascended the ladder 101 and is transitioning to the other side, it can be necessary to secure the grip 155 of the handle assembly 150 in the “up” configuration, e.g., as shown in FIG. 7, so that the grip 155 is available to the user during descent. (It should be understood that the opposite is also true—i.e., when a user wishes to ascend the ladder 101 from the back (B) side of the wall W, the grip is available to the user to aid in ascent from the back side.) As previously noted, when doing so the user may maintain their grip on grip 155, rotating it as desired, e.g., 90°. It should be understood that handle assembly 150 may be placed anywhere in proximity to the ladder 101 to maximize its use as a stabilizing feature of the system 100.

To secure the handle in the “up” configuration, the user can pull the grip 155 upwards, thereby also shifting bracket 160 in the same direction. Slot 171 allows the entire bracket 160/grip 155 assembly to translate upward, until cross-bar member 172 can be received in slot 167.

Ladder assembly 100 and variations thereof can be used in various industries and for a variety of purposes. In one non-limiting example, the ladder assembly 100 can be used for gaining entrance into the bed of a dump truck. Such an approach solves an existing problem of safely gaining access to the dump truck bed without accessing it from the rear tailgate portion which can be difficult, time-consuming, and dangerous, and reduces the need to install costly hatches into the dump body that can be problematic to maintain. The approach also eliminates an alternate option of jumping into the dump body which can cause injury. Furthermore, the ability to remove the ladder 101 from the inside of the dump body, e.g., by flipping it over to the exterior portion of the truck, eliminates damage that could be caused to a permanently-fixed ladder within the dump body.

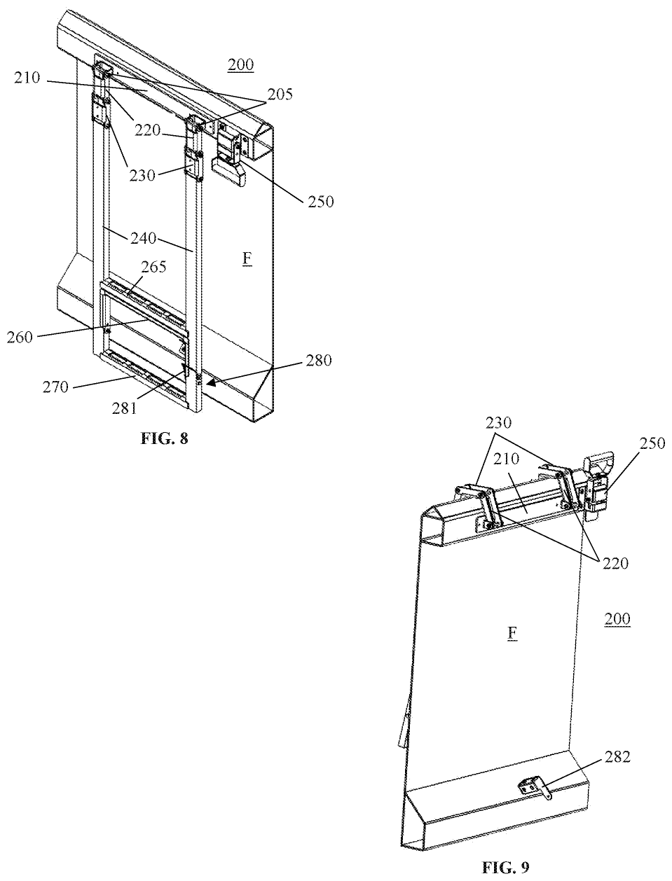

Referring now to FIGS. 8 and 9, a flip-over ladder system 200 (hereinafter ladder 200′) is illustrated according to one embodiment. In this embodiment, the ladder 200 includes a header bar 210. The header bar 210 is securely fastened to a portion of a front wall F, which could be, without limitation, the side of a truck body. Left and right hinge members 205 are securely fastened to, or can be integral with the header bar 210. The left and right hinge members 205 are hingedly connected to left and right first ladder segment members 220, respectively. Left and right second ladder segments 230 are hingedly connected to both the left and right first ladder segments 220 and left and right third ladder segments 240, respectively. Stand-off brace 260 is attached to the third left and right ladder segments 240 as illustrated and is configured to swing out from the third left and right ladder segments 240 in use. An upper step 265 and lower step 270 also span the third left and right ladder segments 240 as illustrated and are configured to carry the weight of a user ascending or descending the ladder.

In this embodiment, a latch assembly 280 is configured to keep the ladder 200 in place. For example, if the ladder 200 is installed on the side of a truck body wall, the latch assembly 280 can be used to keep the ladder 200 from swinging outwardly. The latch assembly 280 also serves to keep the stand-off brace in place in a stowed configuration.

In this embodiment, handle 250 is the same as handle 150 described herein. However, the placement of handle 250 in this embodiment illustrates one of several locations that it may be installed relative to the ladder portion of the system 200.

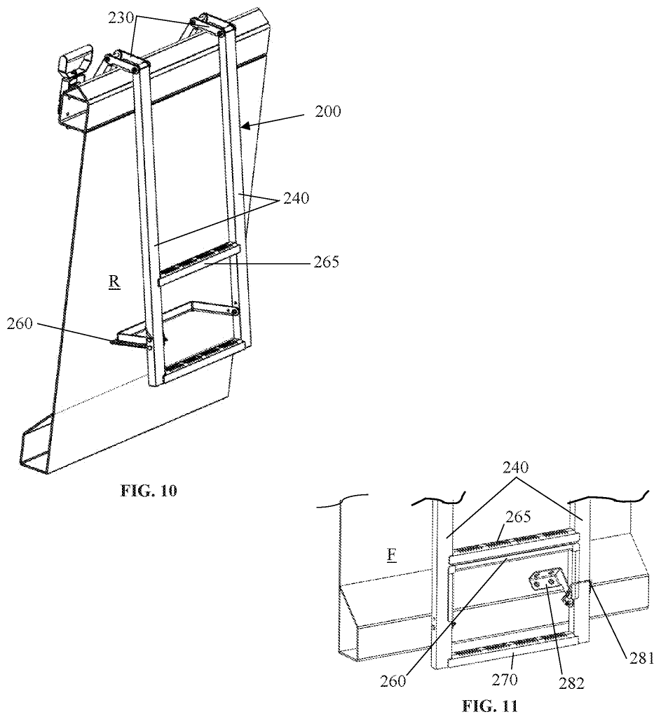

Referring now to FIG. 10, the ladder 200 is shown ‘flipped-over’ the wall, now resting on a rear face R of the wall, opposite the front face F. In this configuration, the second left and right ladder segments 230 span the width of the top of the wall, allowing the third left and right ladders segments 240 to hang straight down or at an angle to account for clearance from the wall when the stand-off brace 260 is deployed, as illustrated. Stand-off brace 260 is shown swung outwardly, to provide a brace for the ladder and also to make the angle between the rear face R of the wall and the ladder less steep for the user to descend.

Referring to FIG. 11, in this embodiment, a latch 282 is securely attached to a portion of the front wall F. The latch is configured to receive a lanyard 281 disposed on the lower portion of the ladder 200 as shown. The lanyard 281 may be brought across the right third segment 240 and locked into the latch 282 to keep the ladder in place. In an alternative approach, the right third segment 240, a leg of the stand-off brace 260 and the latch 282 may each include an aperture, through which a keeper, safety pin or coupler pin can be inserted to lock those components into place.

A number of illustrative embodiments have been described. Nevertheless, it will be understood that various modifications may be made without departing from the spirit and scope of the various embodiments presented herein. Accordingly, other embodiments are within the scope of the following claims.

1. A ladder system, comprising:
a handle assembly configured to be mounted to a front face of a wall;
a ladder assembly, comprising:
first and second rail assemblies defining left and right sides of said ladder assembly;
at least one rung spanning said first and second rail assembly; and
first and second bracket members, each configured to be both secured to said front face of said wall, and to vertically support said first and second rail assemblies, respectively;
wherein each of said first and second rail assemblies comprises a bottom rail segment hingedly coupled to a middle rail segment, a middle rail segment hingedly coupled to an upper rail segment, and wherein said upper rail segment is hingedly connected to said first and second bracket member, respectively; and
wherein said upper rail segment, said middle rail segment and said bottom rail segment are configured to allow said bottom rail segment to be flipped from said front side of said wall to a rear side of said wall, opposite said front side.

2. The ladder system of claim 1, wherein said handle assembly comprises:
a mounting plate;
a locking body integral with said mounting plate; and
a gripping assembly hingedly coupled to said mounting plate.

3. The ladder system of claim 2, wherein said grip member is configured to rotatably translate between first and second positions, wherein in said first position said grip member is oriented downward, and wherein in said second position, said grip member is oriented upward.

4. The ladder system of claim 2, wherein said gripping assembly comprises a bracket member hingedly coupled to said plate member and a grip rotatably coupled to said bracket member, said grip being configured to freely rotate with respect to said bracket member.

5. The ladder system of claim 3, wherein said locking body comprises a slotted aperture allowing said gripping assembly to translate along an axis, and first and second locking apertures configured to selectively lock said gripping assembly in either said first or second position.

6. The ladder system of claim 1, wherein said ladder assembly further comprises a brace member spanning said first and second rail assemblies.

7. The ladder system of claim 6, wherein said brace member is U-shaped.

8. A ladder assembly, comprising:
a handle assembly configured to be mounted to a front face of a wall;
a ladder assembly comprising first and second rails, each of said first and second rails comprising first, second and third hinged segments, said first segment being hingedly coupled to said second segment, and said second segment being hingedly coupled to said third segment;
wherein a length of said second segment is chosen to be longer than the width of said wall onto which said ladder assembly is to be attached; and
wherein said ladder assembly is configured to allow said first and second rails to be rotated such that said first segment remains on the same side of said wall as said front face, said second segment confronts a top portion of said wall, and said third portion is vertically suspended by said second segment on an opposite, rear side of said wall than said front face.

9. The ladder assembly of claim 8, further comprising at least one rung spanning said first and second rail.

10. The ladder assembly of claim 8, wherein each of said first and said second rails is hingedly coupled to a bracket to allow at least 180° rotation of said rails.

11. The ladder assembly of claim 10, wherein said bracket is further configured to be mounted to said front face of said wall.

12. (canceled)

13. The ladder assembly of claim 8, wherein said ladder assembly is configured such that said rails of said third segment is capable of adopting a vertical orientation on both front and rear sides of said wall.

14. The ladder assembly of claim 8, wherein said handle assembly is capable of shifting between upward and downward vertical orientations.

15. The ladder assembly of claim 14, wherein said handle assembly can be reversibly locked in either of said upward or downward vertical orientations.

16. A method for providing access to a dump truck dump body, comprising:
determining a wall thickness at a top portion of said dump body;
providing a ladder system, the ladder system comprising:
a ladder assembly, comprising:
first and second rail assemblies defining left and right sides of said ladder assembly;
at least one rung spanning said first and second rail assembly;
first and second bracket members, each configured to be both secured to an exterior portion of said dump body, and to vertically support said first and second rail assemblies, respectively;
wherein each of said first and second rail assemblies comprises a bottom rail segment hingedly coupled to a middle rail segment, a middle rail segment hingedly coupled to an upper rail segment, and wherein said upper rail segment is hingedly connected to said first and second bracket member, respectively; and
wherein a length of said middle rail segment is selected to be wider than said wall thickness;
providing a handle assembly configured to be mounted to said exterior portion of said dump body; and
attaching said first and second bracket members to said exterior portion of said dump body at a position below said top portion of said dump body that is not greater in length than a length of said first upper rail segment.

17. The method of claim 16, further comprising providing that a grip of said handle assembly is capable of rotating 360°.

18. The method of claim 16, further comprising attaching said handle assembly to said exterior of said dump body such that a grip of said handle can be rotated from a downward orientation to an upward orientation.

19. The method of claim 18, wherein when said grip of said handle is in said upward orientation, said grip is positioned above said top portion of said dump body.

20. The method of claim 16, further comprising positioning said bracket members such that said middle rail segment is capable of laying substantially flush on a surface of said top portion of said dump body.
